(19) United States
(12) Patent Application Publication
(10) Pub. No.: US 2016/0306540 A1
(43) Pub. Date: Oct. 20, 2016

(54) TERMINAL OPERATING METHOD AND TERMINAL

(71) Applicant: YULONG COMPUTER TELECOMMUNICATION SCIENTIFIC (SHENZHEN) CO., LTD., SHENZHEN (CN)

(72) Inventors: Xueying Jing, Shenzhen (CN); Deying Guo, Shenzhen (CN)

(21) Appl. No.: 15/192,372

(22) Filed: Jun. 24, 2016

Related U.S. Application Data
(63) Continuation-in-part of application No. PCT/CN2013/090602, filed on Dec. 26, 2013.

(51) Int. Cl. G06F 3/0484; G06F 3/0488

(52) U.S. Cl. CPC G06F 3/04847; G06F 3/0488

(57) ABSTRACT

The present disclosure provides a terminal operating method. The method comprises: generating at least one contact on a screen interface of a terminal; and if the at least one contact is located at a gap between a bottom edge of the screen interface of the terminal and a function identifier displayed on the screen interface and a preset gesture track is formed by using the contact as a start point, displaying a preset functional interface on the screen interface. The present disclosure also provides a terminal. By using the technical solutions of the present disclosure, operations of a user can be accurately recognized by means of a gap or a slit on a screen interface of a terminal, so that the method is more applicable to one-hand operations of a large-screen terminal.

### CROSS-REFERENCE TO RELATED APPLICATIONS

This application is a continuation in part of international patent application PCT No. PCT/CN2013/090602, filed on Dec. 26, 2013, entitled “TERMINAL OPERATING METHOD AND TERMINAL”, which disclosure is hereby incorporated in its entirety by reference.

### TECHNICAL FIELD

The present disclosure relates to the technical field of terminal operating technology, specifically, to a terminal operating method and a terminal.

### BACKGROUND

Currently, in order to get better visual experience, a terminal and the screen thereof have a larger and larger size, such that when the terminal is held by a user using one hand, generally operations may be performed only on a part of the screen area.

For example, as shown in FIG. 1, when the terminal is held by the user with the left hand or right hand, a left-hand operation area 102 is a sectorial area on the bottom left of the terminal screen, and a right-hand operation area 104 is a sectorial area on the bottom right of the terminal screen, accordingly. Thus, one-hand operations may be performed most readily on objects only within the intersection area of the left-hand operation area 102 and the right-hand operation area 104.

However, the intersection area has a quite limited size, and it is obviously impossible to arrange all the objects in this area, such that it is difficult to perform one-hand operations on objects displayed in other area of the terminal screen, for example a function identifier 106 or an operation panel 108 at the top, etc., which is disadvantageous for the user's operation experience on a large-screen.

Therefore, how to realize a one-hand operation mode applicable to the large-screen terminal becomes a technical problem to be solved urgently.

### SUMMARY

The present disclosure includes implementations that can be addressed to the above technical problem, and proposes a new technical solution which can accurately recognize operations of a user by means of a gap or a slit on a screen interface of a terminal, and is more applicable to one-hand operations of a large-screen terminal.

The present disclosure proposes a terminal operating method, comprising: generating at least one contact on a screen interface of a terminal; if the at least one contact is located at a gap between a bottom edge of the screen interface and a function identifier displayed on the screen interface, and a preset gesture track is formed by using the contact as a start point, displaying a preset function interface on the screen interface.

In this technical solution, since both of the left-hand operation area and the right-hand operating area may cover the bottom edge of the screen interface of the terminal when the large-screen terminal is operated by the user using one hand, it is possible to be applicable to the user's operating process on the larger-screen terminal by recognizing the contact located at the bottom edge.

Meanwhile, by enabling the contact to be located at the gap between the bottom edge of the screen interface and the function identifier, it is possible to be applicable to the large-screen terminal, while facilitating being distinguished from other operation modes, such that the large-screen terminal may be accurately operated, thereby avoiding the occurrence of misoperation.

The function identifier may be a shortcut, a widget, or a display plug-in, etc., displayed on the screen interface of the terminal.

In the above-mentioned technical solution, preferably, the preset gesture track may be located at slits between multiple function identifiers.

In this technical solution, in addition to the definition for the start location of the contact, the specific path of the gesture track may also be defined, for example, may be located at slits between multiple function identifiers, such that on one hand the misoperation on the function identifier may be avoided; on the other hand, it is possible to ensure that the gesture track is effectively distinguished by determining the location of the slit, thereby avoiding the occurrence of misoperation, even if the gesture track has a shape identical with other functional gestures.

In the above-mentioned technical solution, it is preferable to further comprises: when the contact is moved along the preset gesture track, obtaining the movement distance of the contact or the ratio of the movement distance to the preset gesture track; on the basis of the movement distance and the ratio, displaying gradually the preset function interface on the screen interface.

In this technical solution, during the movement of the contact, the preset function interface is gradually displayed on the basis of the movement distance or the ratio. This is advantageous for dynamically combining the display process of the function interface and the movement process of the contact, as if the user “draws out” the function interface by a finger thereof, which is advantageous for improving the user's operation experience.

In the above-mentioned technical solution, preferably, the preset gesture track comprises at least one path corresponding to the at least one contact one to one.

In this technical solution, the contact and the path corresponding to the gesture track may be only one, thereby enabling the user to accurately operate one-handedly by the thumb of the hand holding the terminal. Of course, in order to further enhance the recognizability of the gesture and reduce the occurrence of misoperation, multiple contacts and multiple paths corresponding to the gesture tracks may be used simultaneously.

In the above-mentioned technical solution, preferably, multiple function identifiers are formed with multiple slits, and the terminal operating method further comprises: determining the slit at which the contact is located; and displaying, on the screen interface, the preset function interface corresponding to the slit at which the contact is located.

In this technical solution, multiple types of corresponding modes may be formed between a single contact or multiple contacts generated simultaneously and the slit or slits, such that by recognizing and distinguishing each corresponding mode, multiple types of function interfaces may be enabled respectively, thereby enabling the operation modes of the terminal to be more abundant.

In the above-mentioned technical solution, preferably, the gap includes multiple operation areas, and the terminal operating method further comprises: determining the operation area at which the contact is located; and displaying, on the screen interface, the preset function interface corresponding to the operation area.

In this technical solution, by partitioning the gap between the bottom edge of the screen interface and the function identifier, the function interface required to be enabled by the user may be accurately recognized on the basis of the area at which the contact is located, thereby avoiding the occurrence of misoperation.

In the above-mentioned technical solution, preferably, the preset function interfaces include a panel interface or a function option interface.

In this technical solution, as an implementation, the enabled function interface may be a panel interface for displaying information messages, update messages, issue reminders or switch buttons for application function (for example, whether to enable an airplane mode, or, enable Bluetooth, etc.). Alternatively, the enabled function interface may be a function option interface including switch buttons or enablement interface buttons for other application function (for example, enablement interface for WLAN function or a settings interface) different from those included in the panel interface.

In the above-mentioned technical solution, preferably, the preset function interfaces may include a private application interface, an access interface for private applications, or a selection interface for private application function.

In this technical solution, as an implementation, the gesture operation process of the present disclosure is relatively unique, and thus may be used as a gesture for calling private information, for example, calling the private application interface, etc.. Furthermore, it is possible to avoid displaying, on the screen interface of the terminal, the icons, etc., corresponding to the “private applications” which may be called by the gesture mode of the present disclosure, thereby being advantageous for improving the privacy and preventing other users from knowing the existence of the “private applications”.

The present disclosure further proposes a terminal, comprising: a contact generating unit for generating at least one contact on a screen interface of a terminal; a location determining unit for determining whether the at least one contact is located at a gap between a bottom edge of the screen interface and a function identifier displayed on the screen interface; a track determining unit for determining whether a preset gesture track is formed by using the contact as a start point; and a display controlling unit for displaying a preset function interface on the screen interface, if the location determining unit determines that the at least one contact is located at the gap between the bottom edge of the screen interface and the function identifier, and the track determining unit determines that the preset gesture track is formed by using the contact as a start point.

In this technical solution, since both of the left-hand operation area and the right-hand operating area may cover the bottom edge of the screen interface of the terminal when the large-screen terminal is operated by the user using one hand, it is possible to be applicable to the user's operating process on the larger-screen terminal by recognizing the contact located at the bottom edge.

Meanwhile, by enabling the contact to be located at the gap between the bottom edge of the screen interface and the function identifier, it is possible to be applicable to the large-screen terminal, while facilitating being distinguished from other operation modes, such that the large-screen terminal may be accurately operated, thereby avoiding the occurrence of misoperation.

The function identifier may be an application icon, a shortcut, a widget, or a display plug-in, etc., displayed on the screen interface of the terminal.

In the above-mentioned technical solution, preferably, the preset gesture track is located at slits between multiple function identifiers.

In this technical solution, in addition to the definition for the start location of the contact, the specific path of the gesture track may also be defined, for example, may be located at slits between multiple function identifiers, such that on one hand the misoperation on the function identifier may be avoided; on the other hand, it is possible to ensure that the gesture track is effectively distinguished by determining the location of the slit, thereby avoiding the occurrence of misoperation, even if the gesture track has a shape identical with other functional gestures.

In the above-mentioned technical solution, it is preferable to further comprises a distance obtaining unit for, when the contact is moved along the preset gesture track, obtaining the movement distance of the contact or the ratio of the movement distance to the preset gesture track; the display controlling unit is for, on the basis of the movement distance and the ratio, displaying gradually the preset function interface on the screen interface.

In this technical solution, during the movement of the contact, the preset function interface is gradually displayed on the basis of the movement distance or the ratio. This is advantageous for dynamically combining the display process of the function interface and the movement process of the contact, as if the user “draws out” the function interface by a finger thereof, which is advantageous for improving the user's operation experience.

In the above-mentioned technical solution, preferably, the preset gesture track comprises at least one path corresponding to the at least one contact one to one.

In this technical solution, the contact and the path corresponding to the gesture track may be only one, thereby enabling the user to accurately operate one-handedly by the thumb of the hand holding the terminal. Of course, in order to further enhance the recognizability of the gesture and reduce the occurrence of misoperation, multiple contacts and multiple paths corresponding to the gesture tracks may be used simultaneously.

In the above-mentioned technical solution, it is preferable to further comprises a slit determining unit for, if the multiple function identifiers are formed with multiple slits, determining the slit at which the contact is located; the display controlling unit is for displaying, on the screen interface, the preset function interface corresponding to the slit at which the contact is located.

In this technical solution, multiple types of corresponding modes may be formed between a single contact or multiple contacts generated simultaneously and the slit or slits, such that by recognizing and distinguishing each corresponding mode, multiple types of function interfaces may be enabled respectively, thereby enabling the operation modes of the terminal to be more abundant.

In the above-mentioned technical solution, it is preferable to further comprises an area determining unit for, if the gap includes multiple operation areas, determining the operation area at which the contact is located; the display controlling unit is for displaying, on the screen interface, the preset function interface corresponding to the operation area.

In this technical solution, by partitioning the gap between the bottom edge of the screen interface and the function identifier, the function interface required to be enabled by the user may be accurately recognized on the basis of the area at which the contact is located, thereby avoiding the occurrence of misoperation.

In the above-mentioned technical solution, preferably, the preset function interfaces include a panel interface or a function option interface.

In this technical solution, as an implementation, the enabled function interface may be a panel interface for displaying information messages, update messages, issue reminders or switch buttons for application function (for example, whether to enable an airplane mode, or, enable Bluetooth, etc.). Alternatively, the enabled function interface may be a function option interface including switch buttons or enablement interface buttons for other application function (for example, enablement interface for WLAN function or a settings interface) different from those included in the panel interface.

In the above-mentioned technical solution, preferably, the preset function interfaces may include a private application interface, an access interface for private applications, or a selection interface for private application function.

In this technical solution, as an implementation, the gesture operation process of the present disclosure is relatively unique, and thus may be used as a gesture for calling private information, for example, calling the private application interface, etc.. Furthermore, it is possible to avoid displaying, on the screen interface of the terminal, the icons, etc., corresponding to the “private applications” which may be called by the gesture mode of the present disclosure, thereby being advantageous for improving the privacy and preventing other users from knowing the existence of the “private applications”.

By the above-mentioned technical solution, operations of a user can be accurately recognized by means of a gap or a slit on a screen interface of a terminal, so that the technical solution is more applicable to one-hand operations of a large-screen terminal.

### BRIEF DESCRIPTION OF THE DRAWINGS

FIG. 1 shows a schematic diagram of a interface for operating a terminal in related art;

FIG. 2 shows a schematic flowchart of a terminal operating method according to an implementation of the present disclosure;

FIGS. 3 to 8 shows a schematic diagram of a interface for operating a terminal according to an implementation of the present disclosure;

FIG. 9 shows a schematic block diagram of a terminal according to an implementation of the present disclosure.

FIG. 10 shows a schematic structural diagram of a terminal according to an implementation of the present disclosure.

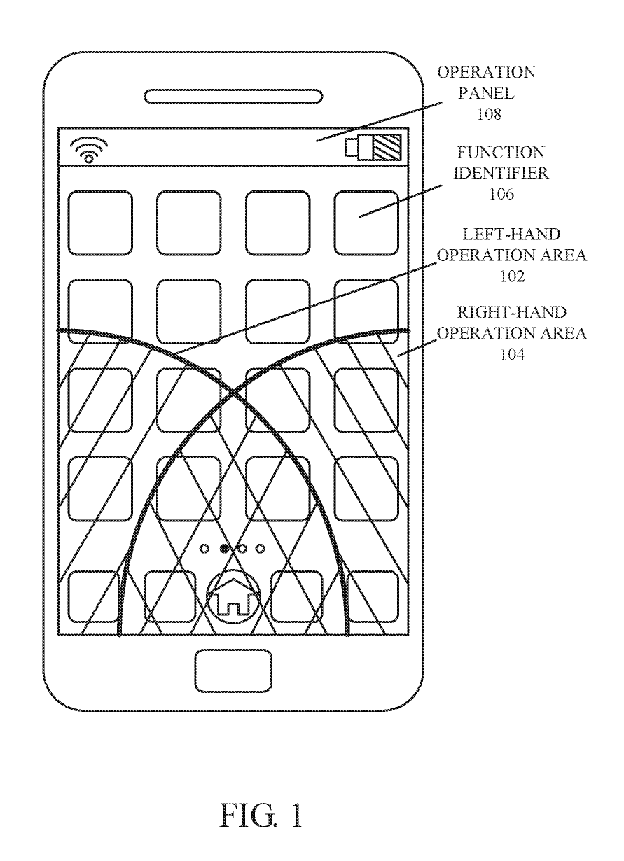

### DETAILED DESCRIPTION

Implementations of the present disclosure are further described in detail hereinafter with reference to the drawings, in order to more fully understand the above-mentioned purposes, features and advantages of the present disclosure. It should be noted that, when not conflicting, the implementations of the present application and features in the implementations could be combined mutually.

A lot of details are set forth in the below description so as to fully understand the present disclosure, however, implementations of the present disclosure may also be implemented by adopting other implementations different from those as described herein, and therefore, the protection scope of the present disclosure is not limited by the implementations disclosed below.

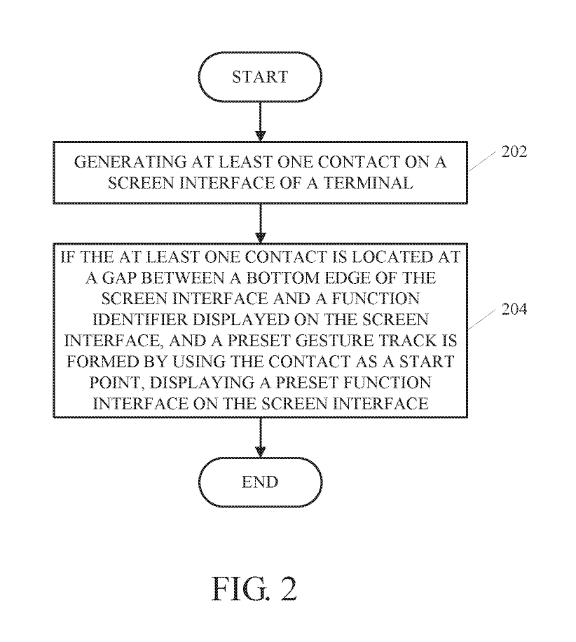

FIG. 2 shows a schematic flowchart of a terminal operating method according to an implementation of the present disclosure.

As shown FIG. 2, a terminal operating method according to an implementation of the present disclosure, comprises:

Step 202: at least one contact is generated on a screen interface of a terminal;

Step 204: if the at least one contact is located at a gap between a bottom edge of the screen interface and a function identifier displayed on the screen interface, and a preset gesture track is formed by using the contact as a start point, a preset function interface is displayed on the screen interface.

In this technical solution, since both of the left-hand operation area and the right-hand operating area may cover the bottom edge of the screen interface of the terminal when the large-screen terminal is operated by the user using one hand, it is possible to be applicable to the user's operating process on the larger-screen terminal by recognizing the contact located at the bottom edge.

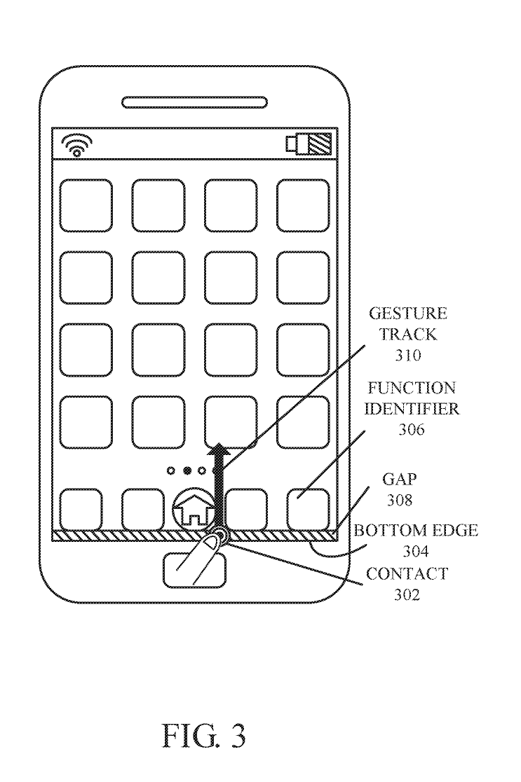

Specifically, as shown in FIG. 3, when the contact 302 is formed on the screen interface of the terminal, if the contact 302 is located at the gap 308 between the bottom edge 304 of the screen interface and the function identifier 306, and the preset gesture track 310 is formed, it is determined that a terminal operating solution according to the present disclosure is required to be performed, so as to display the preset function interface (not shown) on the screen interface.

By enabling the contact 302 to be located at the gap 308 between the bottom edge 304 of the screen interface and the function identifier 306, it is possible to be applicable to the large-screen terminal, while facilitating being distinguished from other operation modes, such that the large-screen terminal may be accurately operated, thereby avoiding the occurrence of misoperation.

Although the function identifier 306 as shown in FIG. 3 is an application icon, in fact, obviously, it may be a shortcut, a widget, or a display plug-in, etc., displayed on the screen interface of the terminal.

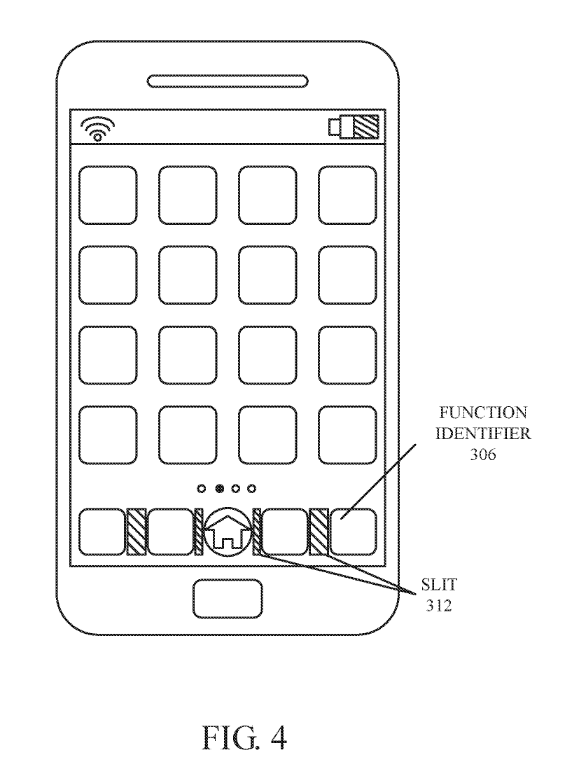

In addition to the location determination for the contact 302, the location of the gesture track 310 may also be defined. For example, as a more preferable implementation, the preset gesture track 310 may be located at slits 312 between multiple function identifiers 306 as shown in FIG. 4.

In this technical solution, in addition to the definition for the start location of the contact 302, the specific path of the gesture track 310 may also be defined, for example, may be located at slits between multiple function identifiers 306, such that on one hand the misoperation on the function identifier 306 (for example, determined as a selection operation on the function identifier 306) may be avoided; on the other hand, it is possible to ensure that the gesture track is effectively distinguished by determining the location of the slit 312, thereby avoiding the occurrence of misoperation, even if the gesture track has a shape identical with other functional gestures.

In the above-mentioned technical solution, preferably, the preset gesture track 310 comprises at least one path corresponding to the at least one contact 302 one to one.

In this technical solution, the contact 302 and the path corresponding to the gesture track 310 may be only one, thereby enabling the user to accurately operate one-handedly by the thumb of the hand holding the terminal. Of course, in order to further enhance the recognizability of the gesture and reduce the occurrence of misoperation, multiple contacts 302 and multiple paths corresponding to the gesture tracks 310 may be used simultaneously.

Assuming that the contact 302 and the corresponding gesture track 310 constitute an operation command for the terminal, multiple different types of operation commands may be formed by changing the quantity of the contacts 302 and the corresponding gesture tracks 310, so as to achieve multiple types of different operation functions.

### EXAMPLE ONE

Preferably, multiple function identifiers 306 are formed with multiple slits 312, and the terminal operating method further comprises: determining the slit 312 at which the contact 302 is located; and displaying, on the screen interface, the preset function interface corresponding to the slit 312 at which the contact 302 is located.

In this technical solution, multiple types of corresponding modes may be formed between a single contact 302 or multiple contacts 302 generated simultaneously and the slit or slits 312, such that by recognizing and distinguishing each corresponding mode, multiple types of function interfaces may be enabled respectively, thereby enabling the operation modes of the terminal to be more abundant.

### EXAMPLE TWO

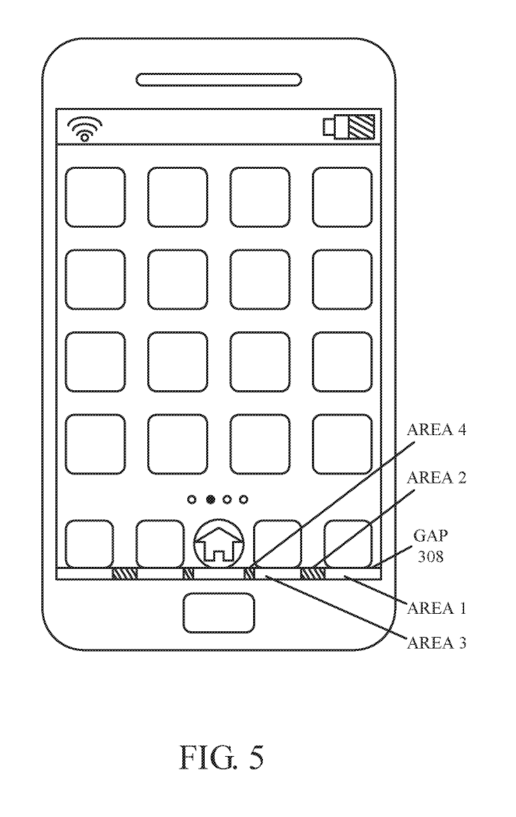

Preferably, the gap 308 includes multiple operation areas, for example area 1, area 2, area 3, and area 4, etc. as shown in FIG. 5. The terminal operating method further comprises: determining the operation area at which the contact 302 is located; and displaying, on the screen interface, the preset function interface corresponding to the operation area.

In this technical solution, by partitioning the gap 308 between the bottom edge 304 of the screen interface 304 and the function identifier 306, the function interface required to be enabled by the user may be accurately recognized on the basis of the area at which the contact 302 is located, thereby avoiding the occurrence of misoperation.

It should be noted that, according to the implementation as shown in FIG. 5, the area 1 and area 3 corresponds to the function identifiers 306 in the vertical direction, while the area 2 and area 4 corresponds to the slits 312 between the function identifiers 306 in the vertical direction. In a preferable implementation, in consideration of misoperating the application icons, the gesture track 310 is required to be located at the gap 312. Thus, the area 1, area 3, etc., may be incorporated into the area 2, area 4, etc., or the contacts 302 at the area 1, area 3, etc., may not be to be recognized. According to another preferable implementation, on the basis of more control function, the location relationship between the gesture track 310 and the gap 312 may not be defined, and the area 1, area 3, etc., may be considered as areas equivalent to the area 2, area 4, etc., for determining the location of the contact 302.

In the above-mentioned technical solution, it is preferable to further comprises: when the contact 302 is moved along the preset gesture track 310, obtaining the movement distance of the contact 302 or the ratio of the movement distance to the preset gesture track 310; on the basis of the movement distance and the ratio, displaying gradually the preset function interface on the screen interface.

In this technical solution, during the movement of the contact 302, the preset function interface is gradually displayed on the basis of the movement distance or the ratio. This is advantageous for dynamically combining the display process of the function interface and the movement process of the contact 302, as if the user “draws out” the function interface by a finger thereof, which is advantageous for improving the user's operation experience.

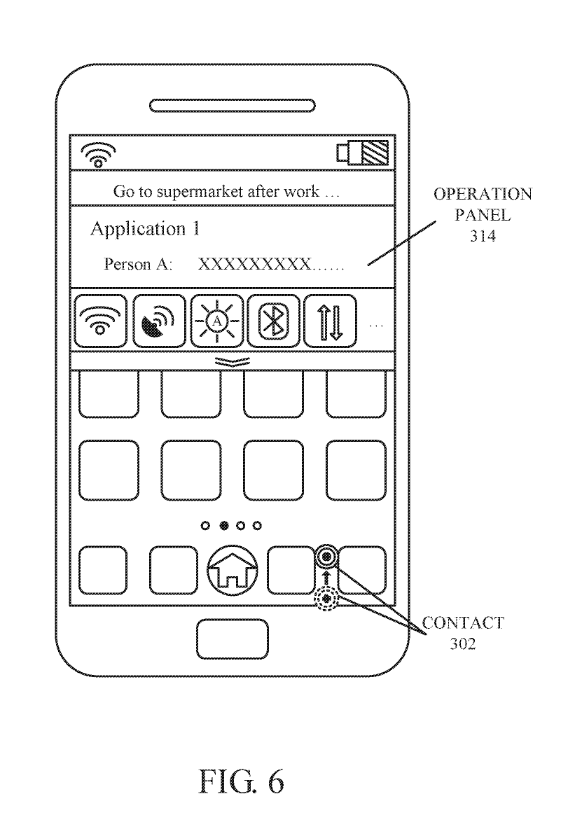

Specifically, for example, the above-mentioned function interface may be an operation panel 314 as shown in FIG. 6. During the movement of the contact 302, the operation panel 314 may gradually decline from the top of the screen interface, and a relationship between the display process of the operation panel 314 and the movement process of the contact 302 is built.

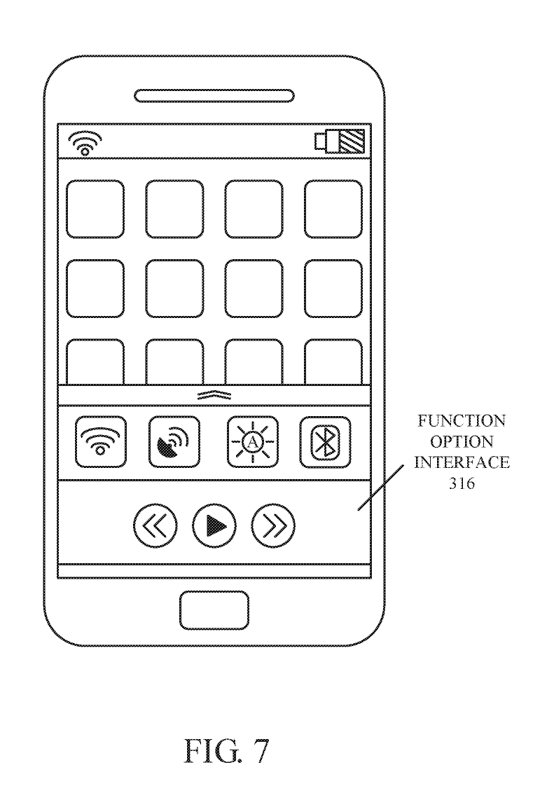

Of course, function interface may have multiple types, and the operation panel 314 is merely an implementation thereof. For example, as another implementation, a function option interface 316 is shown in FIG. 7, and may include switch buttons or enablement interface buttons for other application function (for example, enablement interface for WLAN function or a settings interface) different from those included in the panel interface 314.

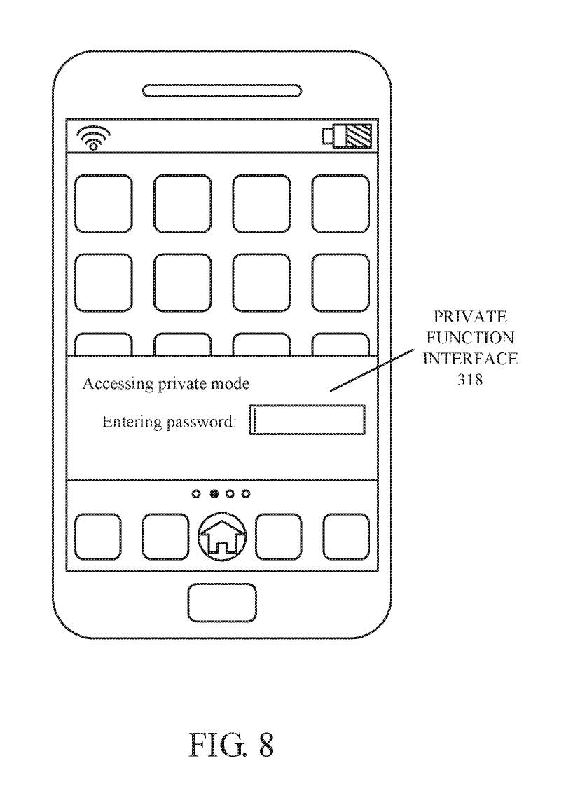

Alternatively, as another implementation of the present disclosure, the preset function interface may also be a private application interface, an access interface for private applications, or a selection interface for private application function. For example, as shown in FIG. 8, the preset function interface may be a private function interface 318.

In this technical solution, as an implementation, the gesture operation process of the present disclosure is relatively unique, and thus may be used as a gesture for calling private information, for example, calling the private function interface 318, etc..

Furthermore, it is possible to avoid, displaying on the screen interface of the terminal, the icons, etc., corresponding to the “private applications” which may be called by the gesture mode of the present disclosure, thereby being advantageous for improving the privacy and preventing other users from knowing the existence of the “private applications”.

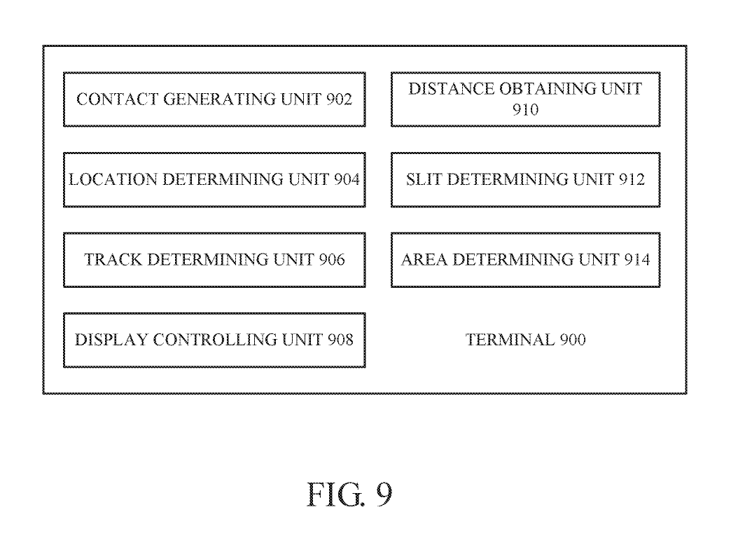

The present disclosure proposes a terminal having a functional module structure corresponding to the above-mentioned terminal operating method. Specifically, FIG. 9 shows a schematic block diagram of a terminal according to an implementation of the present disclosure.

As shown in FIG. 9, a terminal 900 according to an implementation of the present disclosure, comprises: a contact generating unit 902 for generating at least one contact on the screen interface of the terminal 900; a location determining unit 904 for determining whether the at least one contact is located at a gap between a bottom edge of the screen interface and a function identifier displayed on the screen interface; a track determining unit 906 for determining whether a preset gesture track is formed by using the contact as a start point; and a display controlling unit 908 for displaying a preset function interface on the screen interface, if the location determining unit 904 determines that the at least one contact is located at the gap between the bottom edge of the screen interface and the function identifier, and the track determining unit 906 determines that the preset gesture track is formed by using the contact as a start point.

In this technical solution, since both of the left-hand operation area and the right-hand operating area may cover the bottom edge of the screen interface of the terminal 900 when the large-screen terminal 900 is operated by the user using one hand, it is possible to be applicable to the user's operating process on the larger-screen terminal 900 by recognizing the contact located at the bottom edge.

Meanwhile, by enabling the contact to be located at the gap between the bottom edge of the screen interface and the function identifier, it is possible to be applicable to the large-screen terminal 900, while facilitating being distinguished from other operation modes, such that the large-screen terminal 900 may be accurately operated, thereby avoiding the occurrence of misoperation.

The function identifier may be an application icon, a shortcut, a widget, or a display plug-in, etc., displayed on the screen interface of the terminal 900.

In the above-mentioned technical solution, preferably, the preset gesture track is located at slits between multiple function identifiers.

In this technical solution, in addition to the definition for the start location of the contact, the specific path of the gesture track may also be defined, for example, may be located at slits between multiple function identifiers, such that on one hand the misoperation on the function identifier may be avoided; on the other hand, it is possible to ensure that the gesture track is effectively distinguished by determining the location of the slit, thereby avoiding the occurrence of misoperation, even if the gesture track has a shape identical with other functional gestures.

In the above-mentioned technical solution, it is preferable to further comprises a distance obtaining unit 910 for, when the contact is moved along the preset gesture track, obtaining the movement distance of the contact or the ratio of the movement distance to the preset gesture track; the display controlling unit 908 is for, on the basis of the movement distance and the ratio, displaying gradually the preset function interface on the screen interface.

In this technical solution, during the movement of the contact, the preset function interface is gradually displayed on the basis of the movement distance or the ratio. This is advantageous for dynamically combining the display process of the function interface and the movement process of the contact, as if the user “draws out” the function interface by a finger thereof, which is advantageous for improving the user's operation experience.

In the above-mentioned technical solution, preferably, the preset gesture track comprises at least one path corresponding to the at least one contact one to one.

In this technical solution, the contact and the path corresponding to the gesture track may be only one, thereby enabling the user to accurately operate one-handedly by the thumb of the hand holding the terminal 900. Of course, in order to further enhance the recognizability of the gesture and reduce the occurrence of misoperation, multiple contacts and multiple paths corresponding to the gesture tracks may be used simultaneously.

In the above-mentioned technical solution, it is preferable to further comprises a slit determining unit 912 for, if the multiple function identifiers are formed with multiple slits, determining the slit at which the contact is located; the display controlling unit 908 is for displaying, on the screen interface, the preset function interface corresponding to the slit at which the contact is located.

In this technical solution, multiple types of corresponding modes may be formed between a single contact or multiple contacts generated simultaneously and the slit or slits, such that by recognizing and distinguishing each corresponding mode, multiple types of function interfaces may be enabled respectively, thereby enabling the operation modes of the terminal 900 to be more abundant.

In the above-mentioned technical solution, it is preferable to further comprises an area determining unit 914 for, if the gap includes multiple operation areas, determining the operation area at which the contact is located; the display controlling unit 908 is for displaying, on the screen interface, the preset function interface corresponding to the operation area.

In this technical solution, by partitioning the gap between the bottom edge of the screen interface and the function identifier, the function interface required to be enabled by the user may be accurately recognized on the basis of the area at which the contact is located, thereby avoiding the occurrence of misoperation.

In the above-mentioned technical solution, preferably, the preset function interfaces include a panel interface or a function option interface.

In this technical solution, as an implementation, the enabled function interface may be a panel interface for displaying information messages, update messages, issue reminders or switch buttons for application function (for example, whether to enable an airplane mode, or, enable Bluetooth, etc.). Alternatively, the enabled function interface may be a function option interface including switch buttons or enablement interface buttons for other application function (for example, enablement interface for WLAN function or a settings interface) different from those included in the panel interface.

In the above-mentioned technical solution, preferably, the preset function interfaces may include a private application interface, an access interface for private applications, or a selection interface for private application function.

In this technical solution, as an implementation, the gesture operation process of the present disclosure is relatively unique, and thus may be used as a gesture for calling private information, for example, calling the private application interface, etc.. Furthermore, it is possible to avoid displaying, on the screen interface of the terminal, the icons, etc., corresponding to the “private applications” which may be called by the gesture mode of the present disclosure, thereby being advantageous for improving the privacy and preventing other users from knowing the existence of the “private applications”.

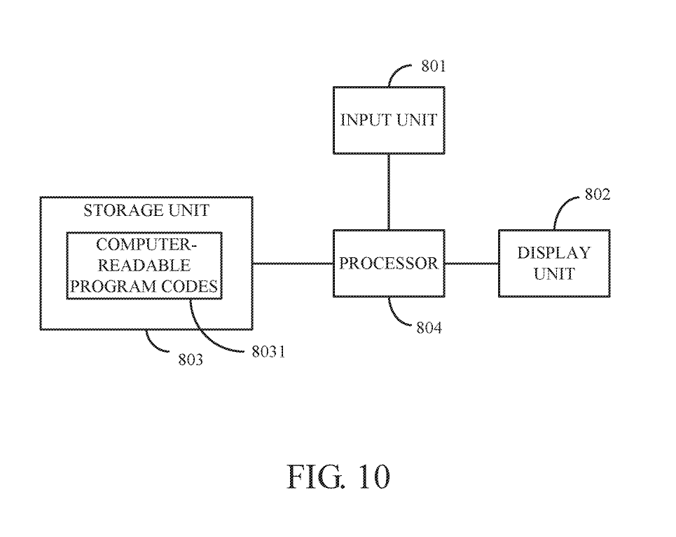

FIG. 10 shows a schematic structural diagram of a terminal according to an implementation of the present disclosure.

As shown in FIG. 10, a terminal according to an implementation of the present disclosure can include but not limited to an input unit 801, a display unit 802, a storage unit 803, and a processor 804. The input unit 801, the display unit 802, and the storage unit 803 are electrically connected to the processor 804.

The input unit 801 is configured to input information to the terminal, such as letters. The input unit 801 may be but not limited to a physical keyboard, a touchscreen, or a combination of the physical keyboard and the touchscreen.

The display unit 802 is configured to display visual information, such as text, image. The display unit 802 may be an LED display screen.

The storage unit 803 is configured to store a plurality of computer-readable program codes 8031. The storage unit 803 can be a read only memory (ROM), a random access memory (RAM), a U-disk, a removable hard disk, etc.

The processor 804 can include multiple cores for multi-thread or parallel processing.

In this implementation, the processor 804 is configured to execute the plurality of computer-readable program codes 8031 to generate at least one contact on the screen interface of the terminal; determine whether the at least one contact is located at a gap between a bottom edge of the screen interface and a function identifier displayed on the screen interface; determine whether a preset gesture track is formed by using the contact as a start point; and display a preset function interface on the screen interface, if the location determining unit determines that the at least one contact is located at the gap between the bottom edge of the screen interface and the function identifier, and the track determining unit determines that the preset gesture track is formed by using the contact as a start point.

In this implementation, the preset gesture track is located at slits between multiple function identifiers.

In this implementation, the processor 804 is further configured to execute the plurality of computer-readable program codes 8031 to, when the contact is moved along the preset gesture track, obtain the movement distance of the contact or the ratio of the movement distance to the preset gesture track; and, on the basis of the movement distance and the ratio, display gradually the preset function interface on the screen interface.

In this implementation, the preset gesture track comprises at least one path corresponding to the at least one contact one to one.

In this implementation, the processor 804 is further configured to execute the plurality of computer-readable program codes 8031 to, if the multiple function identifiers are formed with multiple slits, determine the slit at which the contact is located; and display, on the screen interface, the preset function interface corresponding to the slit at which the contact is located.

In this implementation, the processor 804 is further configured to execute the plurality of computer-readable program codes 8031 to, if the gap includes multiple operation areas, determine the operation area at which the contact is located; and display, on the screen interface, the preset function interface corresponding to the operation area.

In this implementation, the preset function interface is a panel interface or a function option interface.

In this implementation, the preset function interface is a private application interface, an access interface for private applications, or a selection interface for private application function.

The technical solution of the present disclosure is described in detail in conjunction with the accompanying drawings. The present disclosure proposes a terminal operating method and a terminal which can accurately recognize operations of a user by means of a gap or a slit on a screen interface of a terminal, and is more applicable to one-hand operations of a large-screen terminal.

According to an implementation of the present disclosure, a program product stored in a non-volatile machine-readable medium for operating a terminal is provided. The program product comprises machine-executable codes for a computer system to execute the following steps: generating at least one contact on a screen interface of a terminal; if the at least one contact is located at a gap between a bottom edge of the screen interface and a function identifier displayed on the screen interface, and a preset gesture track is formed by using the contact as a start point, displaying a preset function interface on the screen interface.

According to an implementation of the present disclosure, a non-volatile machine-readable medium, for storing a program product for operating a terminal, is further provided. The program product comprises machine-executable codes for a computer system to execute the following steps: generating at least one contact on a screen interface of a terminal; if the at least one contact is located at a gap between a bottom edge of the screen interface and a function identifier displayed on the screen interface, and a preset gesture track is formed by using the contact as a start point, displaying a preset function interface on the screen interface.

According to an implementation of the present disclosure, a machine-readable program, for a machine to execute the terminal operating method according to any one of the above technical solutions, is provided.

According to an implementation of the present disclosure, a storage medium, for storing a machine-readable program for a machine to execute the terminal operating method according to any one of the above technical solutions, is provided.

The foregoing is merely the preferable embodiments or implementations of the present disclosure, and is not intended to limit the present disclosure. For persons skilled in the art, the present disclosure could have various modifications and variations. Any amendments, equivalents, or improvements etc. within the spirit and principle of the present disclosure should be included within the protection scope of the present disclosure.

What is claimed is:

1. A terminal operating method, comprising:
generating at least one contact on a screen interface of a terminal;
when the at least one contact is located at a gap between a bottom edge of the screen interface and a function identifier displayed on the screen interface, and a preset gesture track is formed by using the contact as a start point, displaying a preset function interface on the screen interface.

2. The terminal operating method according to claim 1, wherein the preset gesture track is located at slits between multiple function identifiers.

3. The terminal operating method according to claim 2, further comprising:
when the contact is moved along the preset gesture track, obtaining the movement distance of the contact or the ratio of the movement distance to the preset gesture track;
on the basis of the movement distance and the ratio, displaying gradually the preset function interface on the screen interface.

4. The terminal operating method according to claim 2, wherein the preset gesture track comprises at least one path corresponding to the at least one contact one to one.

5. The terminal operating method according to claim 2, wherein the multiple function identifiers are formed with multiple slits, and
the terminal operating method further comprises:
determining the slit at which the contact is located; and
displaying, on the screen interface, the preset function interface corresponding to the slit at which the contact is located.

6. The terminal operating method according to claim 1, wherein the gap includes multiple operation areas, and
the terminal operating method further comprises:
determining the operation area at which the contact is located; and
displaying, on the screen interface, the preset function interface corresponding to the operation area.

7. The terminal operating method according to claim 1, wherein the preset function interface is a panel interface or a function option interface.

8. The terminal operating method according to claim 1, wherein the preset function interface is a private application interface, an access interface for private applications, or a selection interface for private application function.

9. A terminal, comprising:
a storage unit storing a plurality of computer-readable program codes; and
a processor electrically connected to the storage unit and configured to execute the plurality of computer-readable program codes to:
generate at least one contact on the screen interface of the terminal;
determine whether the at least one contact is located at a gap between a bottom edge of the screen interface and a function identifier displayed on the screen interface;
determine whether a preset gesture track is formed by using the contact as a start point; and
display a preset function interface on the screen interface, if the location determining unit determines that the at least one contact is located at the gap between the bottom edge of the screen interface and the function identifier, and the track determining unit determines that the preset gesture track is formed by using the contact as a start point.

10. The terminal according to claim 9, wherein the preset gesture track is located at slits between multiple function identifiers.

11. The terminal according to claim 10, wherein the processor is further configured to execute the plurality of computer-readable program codes to:
when the contact is moved along the preset gesture track, obtain the movement distance of the contact or the ratio of the movement distance to the preset gesture track; and
on the basis of the movement distance and the ratio, display gradually the preset function interface on the screen interface.

12. The terminal according to claim 10, wherein the preset gesture track comprises at least one path corresponding to the at least one contact one to one.

13. The terminal according to claim 10, wherein the processor is further configured to execute the plurality of computer-readable program codes to:
when the multiple function identifiers are formed with multiple slits, determine the slit at which the contact is located;
display, on the screen interface, the preset function interface corresponding to the slit at which the contact is located.

14. The terminal according to claim 9, wherein the processor is further configured to execute the plurality of computer-readable program codes to:
when the gap includes multiple operation areas, determine the operation area at which the contact is located;
display, on the screen interface, the preset function interface corresponding to the operation area.

15. The terminal according to claim 9, wherein the preset function interface is a panel interface or a function option interface.

16. The terminal according to claim 9, wherein the preset function interface is a private application interface, an access interface for private applications, or a selection interface for private application function.
